(19) United States
(12) Patent Application Publication
(10) Pub. No.: US 2024/0330870 A1
(43) Pub. Date: Oct. 3, 2024

(54) SYSTEMS AND METHODS FOR DETERMINING AND IMPROVING A RELIABILITY METRIC OF AN ELECTRONIC DEVICE BASED ON ENVIRONMENTAL CONDITIONS

(71) Applicant: Lenovo Global Technology (United States) Inc., Morrisville, NC (US)

(72) Inventors: Ananthakrishnan Narayanan, Research Triangle Park, NC (US); Jerry Ackaret, Research Triangle Park, NC (US); Paul Klustaitis, Research Triangle Park, NC (US); Robert Wolford, Research Triangle Park, NC (US)

(21) Appl. No.: 18/129,094

(22) Filed: Mar. 31, 2023

(51) Int. Cl. G06Q 10/20

(52) U.S. Cl. CPC G06Q 10/20

(57) ABSTRACT

Systems and methods for determining and improving a reliability metric of an electronic device based on environmental conditions are disclosed. According to an aspect, a system includes sensors configured to detect different environmental conditions proximate to an electronic device. The sensors are also configured to generate data representative of the detected different environmental conditions. The system also includes a maintenance manager configured to receive the generated data and to determine a reliability metric of the electronic device based on the generated data. Further, the system includes a communications device configured to communicate the reliability metric to a remote computing device.

### TECHNICAL FIELD

The presently disclosed subject matter relates generally to electronic devices. Particularly, the presently disclosed subject matter relates to systems and methods for determining a reliability metric of an electronic device based on environmental conditions.

### BACKGROUND

Electronic devices are used in a wide variety of environments that can affect their reliability for performance level and lifetime. Particularly, an electronic device may be placed in an outside environment with high humidity or high temperatures. These conditions can adversely reduce the electronic device's performance and lifetime. For example, a circuit board exposed to high humidity can lead to corrosion that reduces its reliability. In another example, exposure to high temperature can reduce a processor's performance level.

In order to minimize the effect of adverse environmental conditions, an electronic devices can be proactively placed in a sealed and insulated housing. However, it may be the case that the housing fails to adequately protect the electronic device from all environmental stresses. For example, the housing may be damaged such that moisture can enter the housing to damage the electronic device. In other cases for example, the ambient temperature may be at a level that the insulation does not keep the electronic device adequately cool. In these and other cases, the electronic device may be exposed to environmental conditions that reduce the expected performance and lifetime of the electronic device.

Operators of electronic devices often expect certain performance and lifetime of electronic devices. They utilize this information for planning usage, maintenance and retirement of the electronic devices. Therefore, it is desirable for operators to be informed of changes to expected performance and lifetime of electronic devices under their management.

### BRIEF DESCRIPTION OF THE DRAWINGS

Having thus described the presently disclosed subject matter in general terms, reference will now be made to the accompanying Drawings, which are not necessarily drawn to scale, and wherein:

FIG. 1 is a block diagram of a system for determining a reliability metric of an electronic device based on environmental conditions in accordance with embodiments of the present disclosure;

FIG. 2 is a flow diagram of a method of determining a reliability metric of an electronic device based on environmental conditions in accordance with embodiments of the present disclosure;

FIG. 3 is a block diagram of another system for determining a reliability metric of an electronic device based on environmental conditions in accordance with embodiments of the present disclosure;

FIG. 4 is a block diagram of another system for determining reliability metrics of multiple electronic devices based on environmental conditions in accordance with embodiments of the present disclosure; and

FIG. 5 is a flow diagram of another method of determining a reliability metric of an electronic device based on environmental conditions in accordance with embodiments of the present disclosure.

### SUMMARY

The presently disclosed subject matter relates to systems and methods for determining and improving a reliability metric of an electronic device based on environmental conditions. According to an aspect, a system includes sensors configured to detect different environmental conditions proximate to an electronic device. The sensors are also configured to generate data representative of the detected different environmental conditions. The system also includes a maintenance manager configured to receive the generated data and to determine a reliability metric of the electronic device based on the generated data. Further, the system includes a communications device configured to communicate the reliability metric to a remote computing device.

### DETAILED DESCRIPTION

The following detailed description is made with reference to the figures. Exemplary embodiments are described to illustrate the disclosure, not to limit its scope, which is defined by the claims. Those of ordinary skill in the art will recognize a number of equivalent variations in the description that follows.

Articles “a” and “an” are used herein to refer to one or to more than one (i.e. at least one) of the grammatical object of the article. By way of example, “an element” means at least one element and can include more than one element.

“About” is used to provide flexibility to a numerical endpoint by providing that a given value may be “slightly above” or “slightly below” the endpoint without affecting the desired result.

The use herein of the terms “including,” “comprising,” or “having,” and variations thereof is meant to encompass the elements listed thereafter and equivalents thereof as well as additional elements. Embodiments recited as “including,” “comprising,” or “having” certain elements are also contemplated as “consisting essentially of” and “consisting” of those certain elements.

Unless otherwise defined, all technical terms used herein have the same meaning as commonly understood by one of ordinary skill in the art to which this disclosure belongs.

As referred to herein, the term “electronic device” should be broadly construed and may include any type of electronic device. Example electronic devices include, but are not limited to, a server, an edge device, any equipment having electrical circuitry, or the like. In examples, systems disclosed herein can be used in harsh environments such as cellular network hardware, railroad control electronics, mining equipment electronics, or remote weather station electronics.

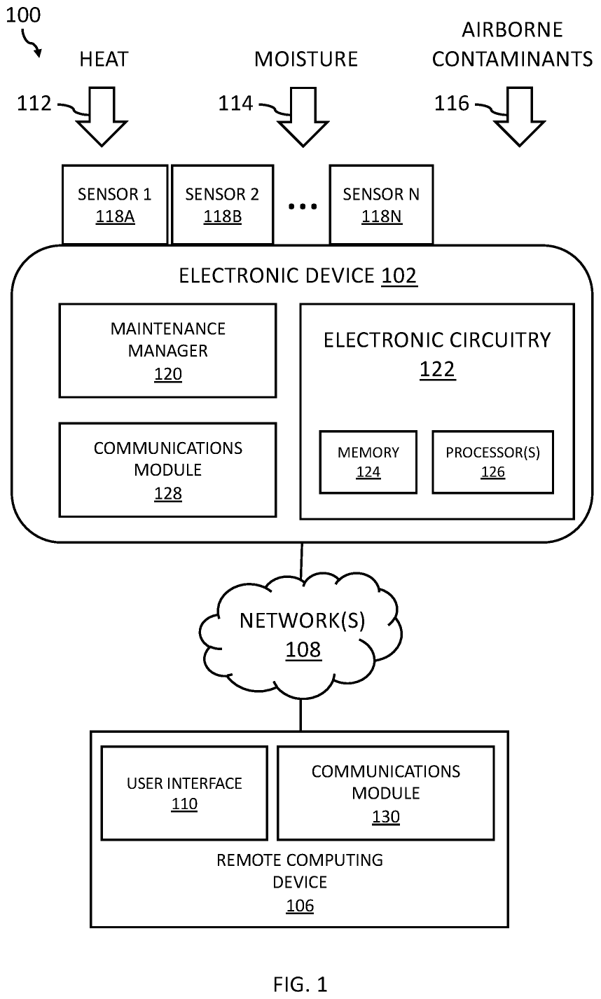

FIG. 1 illustrates a block diagram of a system 100 for determining a reliability metric of an electronic device 102 based on environmental conditions in accordance with embodiments of the present disclosure. Referring to FIG. 1, the system 100 includes a maintenance manager 120 and a computing device 106. The electronic device 102 can be communicatively connected to the remote computing device 106 via one or more communications networks 108. For example, the communications network(s) 108 may include a cellular network, a local area network (LAN), and/or the Internet.

The remote computing device 106 may be utilized for monitoring the functionality and operational status of the electronic device 102. For example, the electronic device 102 can communicate maintenance-related and status information to the remote computing device 106 via the communications network(s) 108. The electronic device 102 may be an edge device, a server, or any other suitable electronic device. The remote computing device 106 may be a desktop computer, a laptop computer, a tablet computer, or any other suitable computing device utilized for monitoring the functionality of the electronic device 102. For example, the remote computing device 106 can receive information and data from the electronic device 102 for use in reliability, availability, maintainability, and serviceability (RAMS) related activities. The received information/data and analysis information related thereto can be presented to an operator of the remote computing device 106 via a user interface 110. As described in more detail herein, the operator can use the data and analysis information for monitoring a condition of the electronic device 102 and an exposure of the electronic device 102 to environmental conditions. In addition, analysis information can provide the operator with real-time actionable feedback and/or recommendations for increasing the probability of attaining RAMS goals and for reducing lifecycle costs of the electronic device 102.

With continuing reference to FIG. 1, the electronic device 102 is situated within an environment where it is exposed to potentially adverse conditions. For example, the electronic device 102 can be exposed to high temperatures of heat 112, moisture 114, and airborne contaminants 116, which are depicted as arrows. The electronic device 102 may also be exposed to other adverse conditions, but for simplicity of illustration in this example only these 3 conditions are provided. Other example adverse conditions include, but are not limited to, pressure, gas, movement, light intensity, noise, vibration, altitude, toxicity or chemical exposure, magnetic field strength, radiation levels, electric fields or currents, flow rate of liquids or gases, acceleration or deceleration, weight or force, torque or twisting force, impact or shock, friction or wear, corrosion, erosion, strain, tension, biological factors (e.g., presence of certain microorganisms or pests), or the like. Sensors 1-N (indicated by references 118A-118N) are configured to detect different environmental conditions proximate to the electronic device 102. Letter “N” is used to indicate that any suitable number of sensors may be utilized for detecting the environmental conditions. One or more of the sensors may be configured to detect a particular environmental condition, such as heat 112, moisture 114, or airborne contaminants (e.g., dust or debris). In this example, sensor 118A is configured to detect heat 112, sensor 118B is configured to detect moisture, and sensor 118N is configured to detect airborne contaminants. An optical sensor can detect an amount of dust. Sensors 118A-118N are also configured to generate data representative of the detected different environmental conditions. For example, sensor 118A can generate a signal indicative of a detected temperature level, sensor 118B can generate a signal indicative of a detected moisture level, and sensor 118N can generate a signal indicative of an amount of detected airborne contaminants. Sensors 118A-118N are shown in this example as being attached to or integrated with the electronic device 102, but it should be understood that one or more of the sensors may be positioned elsewhere in suitable proximity to the electronic device 102 for detecting exposure to its surrounding conditions.

The system 100 can include a maintenance manager 120 configured to receive the generated data from sensors 118A-118N. For example, the maintenance manager 120 can be communicatively connected to sensors 118A-118N for receipt of a signal indicative of the generated data. The maintenance manager 120 and sensors 118A-118N may be communicatively connected via a wired connection or a wireless connection. In this example, the maintenance manager 120 is depicted as residing within or be integrated into the electronic device 102; however, it should be appreciated that maintenance manager 120 may alternatively be apart from the electronic device 102. The maintenance manager 120 can include hardware, software, and/or firmware for implementing the functionalities described herein.

The maintenance manager 120 is configured to determine a reliability metric of the electronic device 102 based on the generated data received from sensors 118A-118N. Particularly, the maintenance manager 120 determine a mission reliability of the electronic device 102 based on the multiple, different conditions detected by sensors 118A-118N. Mission reliability can be a metric indicative of the probability of attaining RAMS goals for the electronic device 102. This information can be useful to an operator for predicting service needed for the electronic device 102. Also, this information can be useful to an operator for taking mitigation actions for improving RAMS expectancy for the electronic device 102.

The electronic device 102 can include electrical circuitry 122 for implementing its functionalities. For example, the electrical circuitry 122 can include memory 124, one or more processors 126, or the like. Other example electrical circuitry includes, but is not limited to, circuit boards (e.g., motherboards), interfaces, wiring, circuitry for signaling condition (e.g., filtering, attenuation, conditioning), analog-to-digital converters, digital logic, power supplies, sensors, digital logic, power supplies, sensors, controllers, actuators, robotic assembly, and the like. Such electrical circuitry can be sensitive to environmental conditions, such as excessive high or low temperatures, excessive moisture, airborne contaminants (e.g., dust), excessive, movement (e.g., high vibrations), gas, and others described herein.

The electronic device 102 includes a communications module 128. The communications module 128 can communicate to the remote computing device 106 via the communications network(s) 108. The remote computing device 106 can also include a communications module 130 for communicating with the electronic device 102 via the communications network(s) 108. The maintenance manager 120 can use the communications module 128 to communicate a reliability metric, environmental condition information, and other data to the remote computing device 106. At the remote computing device 106, the reliability metric, environmental condition information, and other data may be presented via the user interface 110.

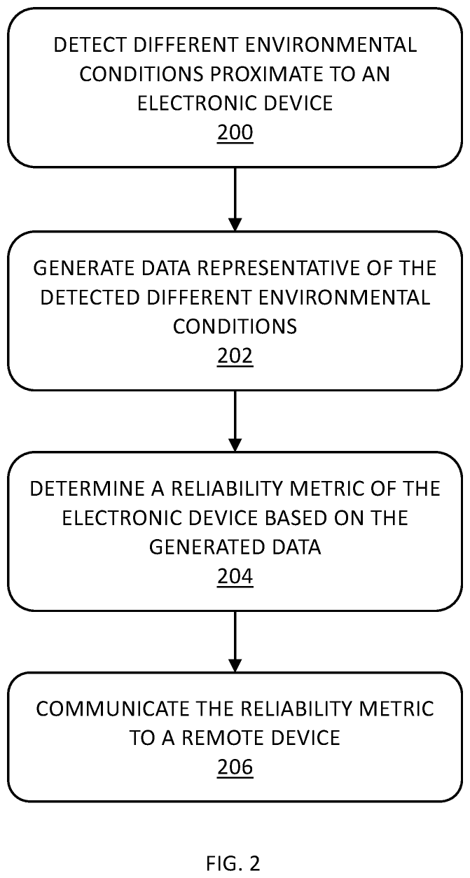

FIG. 2 illustrates a flow diagram of a method of determining a reliability metric of an electronic device based on environmental conditions in accordance with embodiments of the present disclosure. The method is described by example as being implemented by the system 100 shown in FIG. 1. Although it should be understood that the method may be implemented by any suitable system for use in determining a reliability metric of an electronic device.

Referring to FIG. 2, the method includes detecting 200 different environmental conditions proximate to an electronic device. For example, one of the sensors 118A-118N can be a temperature sensor that detects a temperature of air surrounding the electronic device 102. Also for example, one of the sensors 118A-118N can be a moisture meter that detects moisture content of air surrounding the electronic device 102 or within its housing. In another example, one of the sensors 118A-118N can be an airborne contaminant detector that detects an amount of contaminants (e.g., dust) in the air surrounding the electronic device 102 or within its housing.

The method of FIG. 2 includes generating 202 data representative of the detected different environmental conditions. Continuing the aforementioned example, sensors 118A-118N can generate data representative of the detected environmental conditions. Sensors 118A-118N can output the generated data for receipt by the maintenance manager 120. The maintenance manager 120 may store the data in its memory or locally, such as at memory 124. Associated information, such as a time stamp of acquisition of the data, and geographic location may also be stored and associated with the data.

The method of FIG. 2 includes determining 204 a reliability metric of the electronic device based on the generated data. Continuing the aforementioned example, maintenance manager 120 may apply a suitable mathematical model to the data to determine a reliability metric of the electronic device 102. For example, the maintenance manager 120 can apply a regression model or a classification model to the data. The maintenance manager 120 can determine the reliability metric based on a specification of the electronic device. For example, the specification may indicate a specific model, type, or components of the electronic device. This specification information may be factored with the environmental conditions data for determining the reliability metric. The reliability metric may indicate a measure of likelihood of a total failure of the electronic device 102 or a failure of one or more functionalities of the electronic device 102.

The method of FIG. 2 includes communicating 206 the reliability metric to a remote device. Continuing the aforementioned example, the maintenance manager 120 may use the communications module 128 to communicate the reliability metric to the remote computing device 106 via the network(s) 108. In addition, the maintenance manager 120 may use the communications module 128 to communicate some or all of the environmental conditions data or other generated information to the remote computing device 106. At the computing device 106, the user interface 110 may be utilized for presenting (e.g., displaying) text or graphics indicative of the reliability metric, the environmental conditions data, and/or the other generated information to the user for making decisions about maintenance and mitigation actions for the electronic device 102.

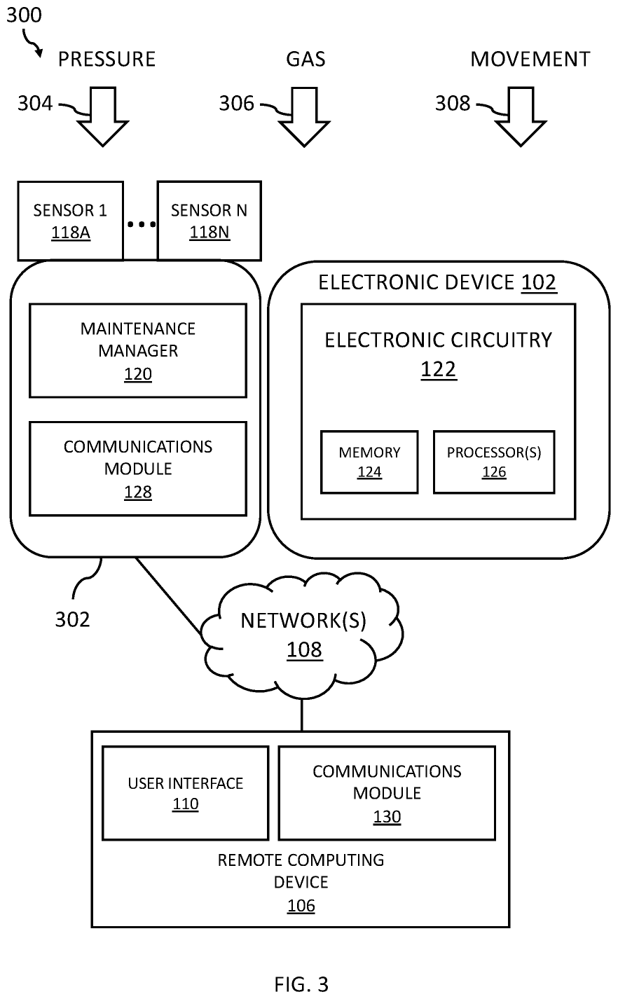

FIG. 3 illustrates a block diagram of another system 300 for determining a reliability metric of an electronic device 102 based on environmental conditions in accordance with embodiments of the present disclosure. Referring to FIG. 3, system 300 is similar to system 100 shown in FIG. 1; however, the maintenance manager 120 is not integrated within the electronic device 102. Rather, the maintenance manager 120 has its own housing 302. In addition, sensors 118A-118N are attached to or otherwise integrated with the housing 302. The communications module 128 is situated within the housing 302, and the electronic device 102 may have its own communications device.

With continuing reference to FIG. 3, sensors 118A-118N may detect the environmental conditions of pressure 304, gas 306, and movement 308. For example, one of the sensors 118A-118N can be a pressure sensor that detects a pressure of air or fluid surrounding the electronic device 102. Also for example, one of the sensors 118A-118N can be a gas sensor that detects a presence or amount of gas surrounding the electronic device 102 or within its housing. The gas sensor may be a corrosive gas sensor. In another example, one of the sensors 118A-118N can be an motion sensor (e.g., accelerometer) that detects motion (e.g., vibration) affecting the electronic device 102. The data and other data of environmental conditions can be used by the maintenance manager 120 for determining a reliability metric of the electronic device 102 in accordance with embodiments of the present disclosure.

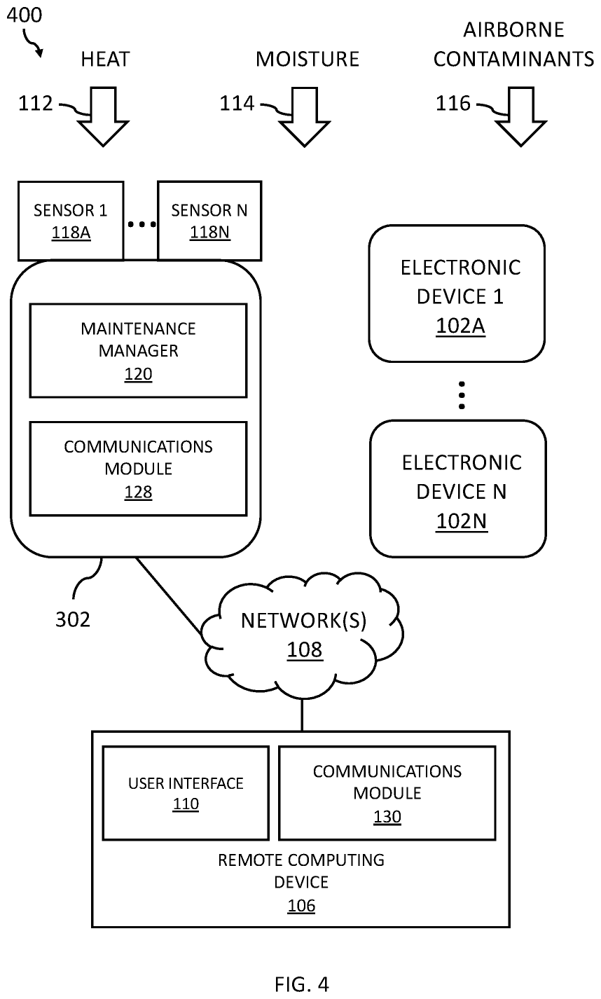

FIG. 4 illustrates a block diagram of another system 400 for determining reliability metrics of multiple electronic devices 1-N (indicated by references 102A-102N) based on environmental conditions in accordance with embodiments of the present disclosure. Referring to FIG. 4, system 400 is similar to system 300 shown in FIG. 3; however, the maintenance manager 120 is used for detecting different environmental conditions proximate to multiple electronic devices 102A-102N.

With continuing reference to FIG. 4, sensors 118A-118N may detect the environmental conditions of heat 112, moisture 114, and airborne contaminants 116. Sensors 118A-118N may be separated and located as different groups for detecting environmental conditions to one or more specific electronic devices among electronic devices 102A-102N. For example, one group of sensors may be located close to electronic device 102A, and another group of sensors may be located close to another electronic device. In this example, the data collected for the sensors for a particular electronic device may be used for determining the reliability metric for that electronic device. The reliability metric determined for the different electronic devices may subsequently be communicated to the remote computing device 106 for presenting to an operator in accordance with embodiments of the present disclosure.

In accordance with embodiments, a maintenance manager can determine a mitigation plan based on data of the environmental conditions. For example, the mitigation plan may be instructions or a suggestions for handling adverse environmental conditions to which an electronic device is being exposed or an accumulation of such exposure. For example, based on the collected environmental condition data, the maintenance manager 120 may generate a mitigation plan that suggests covering the electronic device, mounting the electronic device on a vibration damper, or otherwise. In an example, the maintenance manager 120 may determine that the electronic device 102 is being exposed to an excessive amount of dust, and subsequently recommend covering the electronic device 102 to mitigate harmful effects of such exposure in response to determining the excessive amount of dust. In another example, the maintenance manager 120 may determine that the electronic device 102 is being exposed to an excessive amount of vibration, and subsequently recommend mounting the electronic device 102 on a vibration damper to mitigate harmful effects of such exposure in response to determining the excessive amount of vibration. The maintenance manager 120 can communicate the mitigation plan to the remote computing device 106.

Example mitigation action includes, but are not limited to, replacement of the component within a system which no longer meets minimum reliability target. For example, such components may be a memory module (DIMM) or memory storage device (HDD, SSD) in a computer system; air filter in the HVAC system; fan in the ventilation system; or a cooling loop in the car's radiator or datacenter's chilled water system.

In another example of a mitigation action, additional debris filtering may be added to an air inlet. Further, for example, the mitigation action may include sealing the device and using passive airflow to avoid ingesting contaminants altogether. In another example, the mitigation action may include installing the device in a heated or cooled enclosure. In another example, the mitigation action may include using higher-quality electronic hardware options in the device that allow it to better tolerate the adverse conditions (e.g., higher temp rated options). Further, PCB options can include devices with with conformal coating, and/or watertight connectors.

In other embodiments, a maintenance manager can determine a benefit metric of implementing a mitigation plan. The benefit metric can indicate a change in reliability of an electronic device in the case of implementing a suggested mitigation plan. For example, the benefit metric can indicate an improvement in reliability of the electronic device 102 in the case of a suggested mitigation plan of covering the electronic device 102, mounting the electronic device 102 on a vibration damper, or implementing another mitigation plan. The maintenance manager 120 can communicate the benefit metric to the remote computing device 106.

In other embodiments, a mitigation plan can be implemented by an electronic device. For example, the maintenance manager 120 may determine a mitigation action for implementation by the electronic device 102 based on generated environmental data. The maintenance manager 120 may communicate the mitigation action to electronic circuitry 122 for implementation. For example, a mitigation action may involve halting operation of the electronic circuitry 122, or at least limiting functionality. In an example, a mitigation action can include underclocking one or more of the processors 126 of the electronic device 102. In another example, a mitigation action can include setting an alarm on the electronic device 102 such that a nearby operator can recognize the need for action.

In accordance with embodiment, the maintenance manager is configured to monitor whether one of the different environmental conditions exceeds a threshold level and send an alert in response to determining that the threshold level is exceeded. For example, the maintenance manager 120 may store threshold levels for environmental conditions detected by one or more of sensors 118A-118N. For example, a detected temperature may be monitored and compared to a threshold temperature. In response to determining that the detected temperature exceeds the threshold temperature, then the maintenance manager 120 may use the communications module 128 to send an alert to the remote computing device 106. The remote computing device 106 may present the alert to the operator so that the operator may take appropriate action.

In embodiments, the reliability metric may indicate a total failure of the electronic device or a failure of one or more functionalities of the electronic device. For example, the reliability metric may be represented by a number, color, symbol, or any other suitable indication of a level of reliability. The representation may indicate a total failure of an electronic device or probability of its failure at some time in the future. Similarly, the reliability metric may represent a failure of one or more functionalities of the electronic device. In an example, a reliability metric may provide an operator with an indicator of probability in real time of meeting a RAMS goal. An AI algorithm can use either a regression model (continuous variable example: probability of meeting mission reliability=96%), or a classification model (categorical output example: low risk, medium risk, or high risk).

In embodiments, the maintenance manager can estimate a reduction or improvement in the target lifetime of the electronic device based on the different environmental conditions. For example, environmental conditions may be better than expected such that the probability of the electronic device having a lifetime to an expected time is greater than expected. The communications manager can communicate, to the remote computing device, the estimated reduction or improvement in the target lifetime of the electronic device. In an example, based on the information received, the operator can adjust the output of the system to meet target lifetime for the component(s) or the system.

In embodiments, the maintenance manager can estimate a reduction or improvement in the target lifetime of the electronic device based on an interplay of the different environmental conditions. For example, various combinations of environmental conditions may cause the expected lifetime or performance of the electronic device to improve. The communications manager can communicate, to the remote computing device, the estimated reduction or improvement in the target lifetime of the electronic device.

As noted, any suitable mathematical model may be applied to environmental conditions data for determining a reliability metric of an electronic device. In embodiments, an exponential model can be applied. For example, mission reliability for a target lifetime (Tₘ) of an electronic device in its useful life may be represented by the following equation:

$$R ( {T}_{m} ) = exp ( - λ {T}_{m} )$$

where λ is the inherent failure rate of the electronic device, which may be determined by a prediction model.

When electronic devices are subjected to a harsh environment, the conditions can significantly impact the mission reliability of the electronic devices. To make an accurate reliability model, the impact of these harsh environmental stressors can be considered. Failures associated with some environmental stressors can be modeled while others can be complex. For example, reliability impact of high temperatures can be modeled using an Arrhenius equation as follows:

$$R ( t ) = A \times exp ( \frac{- Ea}{kT} )$$

where Ea is the activation energy in eV, k is the Boltzmann's constant, T is the temperature in degrees Kelvin, and A is a fit parameter for the model. Various other models such as, but not limited to, Peck's, Eyring, and Coffin Manson can be used to model reliability accelerations for different failure modes.

If a system has “n” environmental stressors (represented by S₁, S₂, . . . Sₙ), the impact of the unreliability caused by these stressors can be modeled as:

$$R ( {T}_{m} ) = exp ( - λ {T}_{m} ) - \sum U 1 ( {S}_{i} )$$

where U1(Sᵢ) provides the unreliability of the system due to the impact of time varying stressor Sᵢ.

There may be significant interaction between these environmental stressors, and that may be modeled as follows:

$$R ( {T}_{m} ) = exp ( - λ {T}_{m} ) - \sum U 1 ( {S}_{i} ) - U 2 ( {S}_{1} , {S}_{2} , ... {S}_{n} )$$

where U2 is the unreliability caused by the interaction between stressors S₁, S₂, . . . Sₙ. It is noted that weights U1 and U2 can make a positive or negative impact to reliability.

An artificial intelligence (AI) based model can be used to determine the weights of U1 and U2. The model can predict the real time probability of meeting the mission reliability goals of the electronic devices. Also, the model can factor the cumulative effect of all time-varying environmental stressors or conditions. The model can also provide actionable feedback to the user to increase a probability of success.

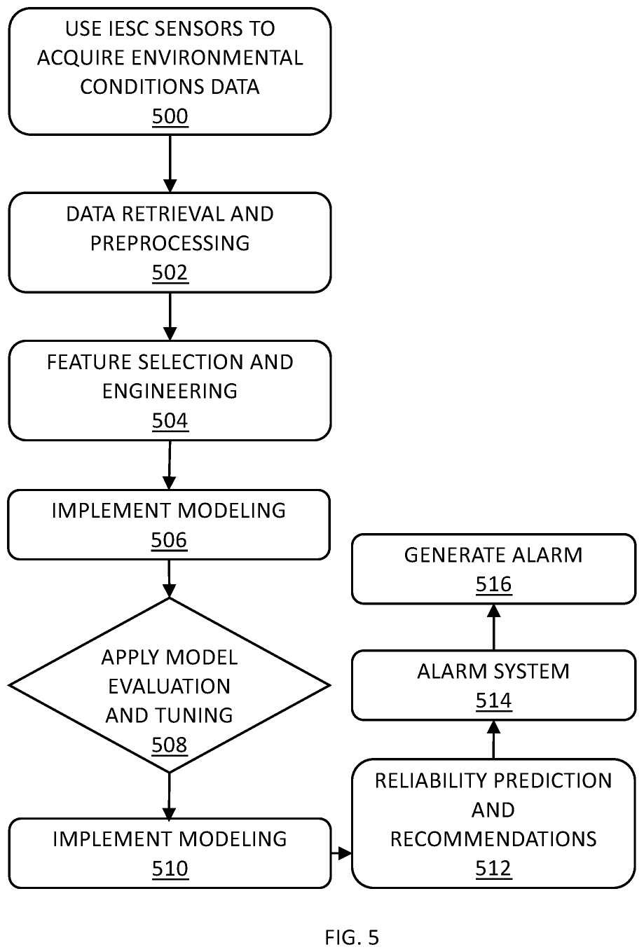

FIG. 5 illustrates a flow diagram of another method of determining a reliability metric of an electronic device based on environmental conditions in accordance with embodiments of the present disclosure. The method is described by example as being implemented by a reliability manager, such as the reliability manager 120 shown in FIG. 1. Although it should be understood that the method may be implemented by any suitable system for use in determining a reliability metric of an electronic device.

Referring to FIG. 5, the method includes using 500 sensors of an integrated environmental sensor card (IESC) to acquire environmental conditions data. For example, the reliability manager 120 can includes an IESC with sensors for acquiring the data. The IESC may be a standalone board or integrated as part of existing hardware. The IESC may be mounted close to an electrical device of interest. For example, the IESC may be mounted to a chassis of a server, a server rack, a co-located datacenter room, an edge remote location cabinet, and the like. Multiple IESCs may be deployed at a location near one or more electronic devices being monitored. Field service and reliability data may be acquired by the reliability manager 120. The method also includes data retrieval and preprocessing 502.

The method of FIG. 5 includes feature selection and engineering 504. For example, selected features include, but are not limited to, environmental parameters, activation energies for standalone failure models (e.g., Arrhenius, Peck's, Eyring, Coffin Manson, etc.), and acceleration factors. Feature selection and engineering can be used to feed the model with explanatory variables, labeled datasets, features (dependent variables), scaling, and transformation functions. In an example, environmental stress data may be retrieved by a call home service over any suitable communication medium or technique such as, but not limited to, wireless communication, direct point-to-point copper or optical communication, or an device data (e.g., telemetry data from sensors, warning/failure alert logs, system error logs, or service logs).

With continuing reference to FIG. 5, the method includes implementing 506 modeling. For example, any of the aforementioned models may be applied. An AI algorithm may be applied to the model. AI algorithms can be regression or classification. Regression predicts a continuous output, and classification predicts a categorical output. Some examples of regression models include linear regression, lasso regression, and the like. Some examples of classification models includes logistic regression, K-Nearest neighbors, and the like. In addition, the model may also be an unsupervised learning models that provides recommendation to the user to change environmental conditions or operating stress.

The method of FIG. 5 includes applying 508 model evaluation and tuning. For example, the dataset can be split into test and train datasets. A model can be selected and fit on a fraction of the data, referred to as the train data, and their performance can be compared against the test dataset. This can be done iteratively until the best model is selected, and the algorithm is tuned to obtain the desired performance. If the model is satisfactory, the method may proceed to implementing 510 the model for use on electronic device(s). This may be based on one or more appropriate (commonly used) evaluation techniques such as accuracy, recall, sensitivity, specificity, etc. Model deployment can include integrating the AI solution in the field to make real time predictions based on the data. Subsequently, the method includes reliability prediction and recommendations at step 512.

The method also includes providing 514 and alarm system that may generate 516 an alarm in response to the environmental conditions or reliability metric meeting a predefined level. In an example, a built-in alarm system can alert the operator when there is an environmental excursion outside the programmable allowable range using predefined and programmable inputs such as ASHRAE standards, thresholds for various failure mode activations, AI algorithm recommendations, etc.

The present subject matter may be a system, a method, and/or a computer program product. The computer program product may include a computer readable storage medium (or media) having computer readable program instructions thereon for causing a processor to carry out aspects of the present subject matter.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a RAM, a ROM, an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network, or Near Field Communication. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present subject matter may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++, Javascript or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present subject matter.

Aspects of the present subject matter are described herein with reference to flowchart illustrations and/or block diagrams of methods, apparatus (systems), and computer program products according to embodiments of the subject matter. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present subject matter. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the embodiments have been described in connection with the various embodiments of the various figures, it is to be understood that other similar embodiments may be used, or modifications and additions may be made to the described embodiment for performing the same function without deviating therefrom. Therefore, the disclosed embodiments should not be limited to any single embodiment, but rather should be construed in breadth and scope in accordance with the appended claims.

What is claimed is:

1. A system comprising:
a plurality of sensors configured to detect different environmental conditions proximate to an electronic device, and configured to generate data representative of the detected different environmental conditions;
a maintenance manager configured to receive the generated data and to determine a reliability metric of the electronic device based on the generated data; and
a communications device configured to communicate the reliability metric to a remote computing device.

2. The system of claim 1, wherein the different environmental conditions comprise pressure, temperature, humidity, gas, airborne contamination, and/or movement.

3. The system of claim 1, wherein the plurality of sensors are a plurality of first sensors, wherein the electronic device is a first electronic device,
wherein the system further comprises a plurality of second sensors configured to detect different environmental conditions proximate to a second electronic device, and configured to generate data representative of the detected different environmental conditions proximate to the second electronic device,
wherein the maintenance manager is configured to receive the generated data representative of the detected different environmental conditions proximate to the second electronic device and to determine a reliability metric of the second electronic device based on the generated data representative of the detected different environmental conditions proximate to the second electronic device, and
wherein the communications device is configured to communicate the reliability metric of the second electronic device to the remote computing device.

4. The system of claim 1, wherein the electronic device comprises one of an edge device, a server, or a microcontroller.

5. The system of claim 1, wherein the communications device is configured to wirelessly communicate the reliability metric to the remote computing device.

6. The system of claim 1, wherein the maintenance manager is configured to apply one of a regression model or a classification model to the generated data to determine the reliability metric.

7. The system of claim 1, wherein the maintenance manager is configured to determine a mitigation plan based on the generated data, and
wherein the communications manager is configured to communicate the mitigation plan to the remote computing device.

8. The system of claim 7, wherein the mitigation plan comprises one of covering the electronic device, mounting the electronic device on a vibration damper, or replacing or removing a component or sub-system.

9. The system of claim 7, wherein the maintenance manager is configured to determine a benefit metric of implementing the mitigation plan, and wherein the communications device communicates the benefit metric to the remote computing device.

10. The system of claim 1, wherein the maintenance manager is configured to determine a mitigation action based on the generated data, and configured to instruct the electronic device to implement the mitigation action.

11. The system of claim 1, wherein the maintenance manager is configured to determine the reliability metric based on a specification of the electronic device.

12. The system of claim 1, wherein the maintenance manager is configured to monitor whether one of the different environmental conditions exceeds a threshold level, and configured to control the communications manager to communicate an alert to the remote computing device in response to determining that one of the different environmental conditions exceeds the threshold level.

13. The system of claim 1, wherein the reliability metric is indicative of a total failure of the electronic device or a failure of one or more functionalities of the electronic device.

14. The system of claim 1, wherein the maintenance manager is configured to determine the reliability metric based on a failure rate of the electronic device and a target lifetime of the electronic device.

15. The system of claim 14, wherein the maintenance manager is configured to estimate a reduction or improvement in the target lifetime of the electronic device based on the different environmental conditions, and
wherein the communications manager is configured to communicate, to the remote computing device, the estimated reduction or improvement in the target lifetime of the electronic device.

16. The system of claim 14, wherein the maintenance manager is configured to estimate a reduction or improvement in the target lifetime of the electronic device based on an interplay of the different environmental conditions, and
wherein the communications manager is configured to communicate, to the remote computing device, the estimated reduction or improvement in the target lifetime of the electronic device.

17. A method comprising:
using a plurality of sensors configured to detect different environmental conditions proximate to an electronic device;
generating data representative of the detected different environmental conditions;
determining a reliability metric of the electronic device based on the generated data; and
communicating the reliability metric to a remote computing device.

18. The method of claim 17, wherein the different environmental conditions comprise pressure, temperature, humidity, gas, airborne contamination, and/or movement.

19. The method of claim 17, further comprising:
determining a mitigation plan based on the generated data; and
communicating the mitigation plan to the remote computing device.

20. The method of claim 17, wherein the mitigation plan comprises one of covering the electronic device, mounting the electronic device on a vibration damper, or replacing or removing a component or sub-system.
